(19) United States
(12) Patent Application Publication
(10) Pub. No.: US 2013/0023605 A1
(43) Pub. Date: Jan. 24, 2013

(54) CURABLE COMPOSITIONS

(71) Applicants: Bernd Hoevel, Sinzheim (DE); Oliver Barleben, Rheinau (DE); Matthias Koch, Biberach (DE)

(72) Inventors: Bernd Hoevel, Sinzheim (DE); Oliver Barleben, Rheinau (DE); Matthias Koch, Biberach (DE)

(73) Assignee: DOW GLOBAL TECHNOLOGIES LLC, Midland, MI (US)

(21) Appl. No.: 13/637,719

(22) PCT Filed: Mar. 30, 2011
(86) PCT No.: PCT/US11/00570

§ 371 Date: Sep. 27, 2012

Related U.S. Application Data
(60) Provisional application No. 61/319,594, filed on Mar. 31, 2010.

(51) Int. Cl. C08L 63/00; C08K 3/40; C08K 3/36

(52) U.S. Cl. 523/466

(57) ABSTRACT

A curable composition comprising (A) a resin component, comprising (i) an epoxy compound, (ii) a diluent, and (Hi) a first filler and (B) a hardener component, comprising (iv) a curing agent, (v) a second filler, and (vi) a non-reactive polyether block copolymer additive. The resin component and hardener component each having a viscosity of no greater than 30 Pascal-second under an applied shear of 10 reciprocal seconds at 25 degrees Celsius and the curable composition after 120 seconds of mixing the resin component and hardener component together under an applied shear of 10 reciprocal seconds has a viscosity of at least 100 Pascal-second at 25 degrees Celsius.

### FIELD OF THE INVENTION

This invention relates to curable compositions, and in particular curable compositions that include a resin component and a hardener component.

### BACKGROUND

Epoxy systems consist of two components that can react with each other to form a cured epoxy. The first component (hereinafter referred to as the “resin component”) includes an epoxy resin and the second component (hereinafter referred to as the “hardener component”) includes a curing agent sometimes called a hardener. The resin component and the hardener component can be combined to form a curable composition, which can then be crosslinked, i.e., cured, and used in a wide range of applications. For example, a cured epoxy can be used in adhesives, coatings, fiber-reinforced plastic materials, composite materials, electrical laminates, and many other applications.

Depending on the application, various properties of the curable composition and/or the individual components may be altered. In adhesive applications it may be advantageous for the viscosity of the curable composition to be similar to a paste to provide resistance to slump, which is a change in shape once the curable composition has been placed in a desired location. Increasing the viscosity to provide sufficient resistance to slump can allow the curable compositions to be applied in various directions and in applications where there is a large bonding gap.

To increase the viscosity of the curable composition, previous approaches have incorporated fillers into one or both of the components. However, incorporating fillers can also increase the viscosity of the resin and hardener components prior to forming the curable composition. Increasing the viscosity of the two components individually can lead to a difficulty in mixing, which can lead to poor mixing and thereby reduce the properties of the cured epoxy. Additional drawbacks can include making it difficult to transfer and/or pump the two components, along with making it difficult to quickly dispense the curable composition to a desired location. Moreover, increasing the viscosity of the two components prior to forming the curable composition can increase the risk of entrapping air, which can act as a defect starting point for cracks. Furthermore, as the amount of fillers increase the toughness of the cured epoxy can decrease.

### SUMMARY

The present invention provides one or more embodiments of curable compositions. For one or more of the embodiments of the present invention, the curable compositions comprise (A) a resin component, comprising (i) an epoxy compound, (ii) a diluent, and (iii) a first filler and (B) a hardener component, comprising (iv) a curing agent, (v) a second filler, and (vi) a non-reactive polyether block copolymer additive. The resin component and hardener component each have a viscosity of no greater than 30 Pascal-second (Pa·s) at 25 degrees Celsius (° C.) under an applied shear of 10 reciprocal seconds (l/s) and the curable composition after 120 seconds of mixing the resin component and the hardener component together under an applied shear of 10 reciprocal seconds has a viscosity of at least 100 Pascal-second at 25 degrees Celsius.

Various embodiments also include a process for preparing the curable composition comprising the steps (a) forming a resin component having a viscosity of no greater than 30 Pa·s at 25° C. under an applied shear of 10 l/s by mixing together the
(i) epoxy compound, (ii) diluent, and (iii) first filler and (b) forming a hardener component having a viscosity of no greater than 30 Pa·s at 25° C. under an applied shear of 10 l/s by mixing together the (iv) curing agent, (v) second filler, and (vi) non-reactive polyether block copolymer additive. For the embodiments, the process includes
(c) mixing the resin component and the hardener component together to form the curable composition, wherein 120 seconds after mixing the resin component and the hardener component together at an applied shear of 10 l/s the curable composition has a viscosity of at least 100 Pa·s at 25° C.

Additionally, the present invention provides for two or more substrates bonded together with a cured epoxy formed with the curable compositions, described herein. For example, the embodiments of the present invention may be used to bond two halves of a windmill blade together.

### DETAILED DESCRIPTION

The term “thixotropy” refers to a property of a material where the viscosity of the material under an applied shear is lower than the viscosity of the material under no applied shear.

The term “toughness” refers to impact resistance and fracture resistance of a cured epoxy.

For the embodiments, (A) a resin component and (B) a hardener component (together referred to as the “two components”) are mixed together to form a curable composition. The curable composition can be cured to form a cured epoxy that can be used, for example, as an adhesive joint.

The (A) resin component comprises (i) an epoxy compound, (ii) a diluent, and (iii) a first filler. The (B) hardener component comprises (iv) a curing agent, (v) a second filler, and (vi) a non-reactive polyether block copolymer additive that imparts thixotropy to the curable composition. Additionally, the cured epoxy formed by curing the curable composition has an increased toughness as compared to a cured epoxy without the non-reactive polyether block copolymer additive

For the embodiments, the non-reactive polyether block copolymer additive achieves the combined effect of imparting thixotropy to the curable composition and increasing the toughness of the cured epoxy as compared to a cured epoxy without the non-reactive polyether block copolymer additive. Surprisingly, however, the non-reactive polyether block copolymer additive does not increase the viscosity of the hardener component alone. For the embodiments, the non-reactive polyether block copolymer additive, among other things, can minimize an amount of the first and/or second filler and allow for greater control to adjust other additives within the resin component and hardener component of the curable composition, as discussed herein.

For the embodiments, the curable compositions may be useful as an adhesive. The viscosity of the resin component and the hardener component do not increase prior to forming the curable composition. However, when the resin component and hardener component are mixed together to form the curable composition the viscosity of the curable composition begins to increase, as discussed more fully herein. For the embodiments, the non-reactive polyether block copolymer additive imparts thixotropy to the curable composition. Applying a shear force to the curable composition to mix the resin component and the hardener component together, the viscosity starts relatively low allowing for thorough mixing. However, as mixing continues and, in particular, once the applied shear is removed, the viscosity of the curable composition increases allowing the curable composition to maintain its shape once it is deposited in a desired location. For the embodiments, the viscosity of the curable composition can help to allow air to escape, which reduces the amount of entrapped air and minimizes the defect starting points for cracks. For the embodiments, the curable composition of the present invention provides sufficient resistance to slump to allow the curable compositions to be applied in various directions and in situations where large bonding gaps are required, e.g., greater than 5 centimeters (cm).

The epoxy compound refers to a compound in which an oxygen atom is directly attached to two adjacent or non-adjacent carbon atoms of a carbon chain or ring system. For example, the epoxy compound can be a liquid, a liquid mixture of one or more solid epoxy resins with one or more liquid epoxy resins, or solid epoxy resins dissolved in a diluent. The epoxy compound of the present invention can be monomeric, polymeric, saturated, unsaturated, aliphatic, cycloaliphatic, aromatic or heterocyclic.

For the embodiments, the epoxy compound can be selected from, but not limited to, a polyglycidyl ether of a polyhydric alcohol, a polygycidyl ether of a polyhydric phenol, a novolac formed from formaldehyde and a phenol, or mixtures thereof. Examples of polyglycidyl ethers of a polyhydric alcohol include, but are not limited to, 1,4-butanediol, 1,3-propanediol, C₁₂-C₁₄ alkylalkohol, tri-methylol-propane, 1,6-hexanediol, cycloaliphatic epoxy resins, or mixtures thereof. Examples of cycloaliphatic epoxy resins include, but are not limited to, 3,4-epoxycyclohexylmethyl-3,4-epoxycyclohexane carboxylate, bis(3,4 epoxycyclohexylmethyl)-adipate, or mixtures thereof. Examples of polyglycidyl ethers of a polyhydric phenol include, but are not limited to, bis(4-ydroxyphenyl)methane (bisphenol F), 2,2,-bis-(4-hydroxyphenyl)propane (bisphenol A), cyclododecanone-bisphenol-A, di-phenol-sulphone, styrenated-phenol, or mixtures thereof For the embodiments, the epoxy compound is preferably bisphenol A digycidyl ether, bisphenol F digycidyl ether, or C₁₂-C₁₄ methylgycidyl ether. For the embodiments, the amount of the epoxy compound can be within a range of from 10 weight percent (wt %) to 90 wt %, preferably within a range of from 50 wt % to 80 wt %, and more preferably within a range of from 60 wt % to 80 wt %, based on a total weight of the resin component.

For the embodiments, the diluent in the resin component can be a reactive diluent and participate in a chemical reaction with at least one or more other materials in the curable composition during curing and becomes incorporated into the cured epoxy. Alternatively, the diluent can also be non-reactive. Diluents can be used to vary the cure characteristics, extend pot life, improve adhesion properties of the curable compositions, and adjust the viscosity of curable compositions. For the embodiments, the diluent is optional. If the diluent is used, the amount used in the resin component can be within a range of from 1 wt % to 90 wt %, preferably within a range of from 2 wt % to 50 wt %, and more preferably within a range of from 3 wt % to 20 wt %, based on the total weight of the resin component. For the embodiments, the diluent is present in the resin component; however, the diluent may also be present in the hardener component.

For the embodiments, the diluent is a polymeric glycidyl ether. The polymeric glycidyl ether can be formed from units which include polyalkylene oxide reacted with epichlorohydrin to form glycidyl ethers. The glycidyl ether can be selected from the group consisting of allyl glycidyl ethers, diglycidyl ethers, phenyl glycidyl ethers, alkyl glycidyl ethers, or mixtures thereof. Sometimes, polymeric glycidyl ethers can be formed by a reaction of mono- to poly-hydroxyl compounds with alkylene oxides and a conversion of the polyetherpolyol reaction product into a glycidyl ether with epichlorohydrin and subsequent treatment of the former intermediate with aqueous sodium hydroxide. Additionally, cycloaliphatic epoxy resins can be used as the diluent. A specific example of the polymeric glycidyl ether includes, but is not limited to, neopentylgycidyl ether.

For the embodiments, the first filler in the resin component is fumed silica and used in an amount no greater than 10 wt % based on the total weight of the resin component. Additionally, the first filler can include other fillers including, but not limited to, colloidal silica, bentonite clay, mica, atomized aluminum powder, glass fibers, talc, kaolin, metal oxides, or mixtures thereof. The other optional first fillers can be used in an amount within a range of from 1 wt % to 30 wt %, preferably within a range of from 2 wt % to 20 wt %, and more preferably within a range of from 5 wt % to 10 wt %, based on the total weight of the resin component. For the embodiments, the first filler is preferably fumed silica.

As discussed above, the hardener component of the present invention includes a non-reactive polyether block copolymer additive. The non-reactive polyether block copolymer additive does not chemically react, or participate in a chemical reaction, with other materials in the resin component or the hardener component. For the embodiments, the non-reactive polyether block copolymer additive can be formed from two or more amphiphilic polyether block copolymer additive segments. Examples of amphiphilic polyether block copolymer additive segments include, but are not limited to, a diblock copolymer, a linear triblock copolymer, a linear tetrablock copolymer, a higher order multiblock copolymer, a branched block copolymer, a star block copolymer, or mixtures thereof. Specific examples of the non-reactive polyether block copolymer include, but are not limited to, Fortegra 100™, available from The Dow Chemical Company, Dow Coming® 1248, Dow Corning® 190, and Dow Coming® 5329, available from Dow Coming Corporation, or mixtures thereof.

Additional examples of non-reactive polyether block co-polymer additives include silicone non-reactive polyether block copolymers. Examples of silicone non-reactive polyether block copolymers include, but are not limited to, compounds of Formula I:

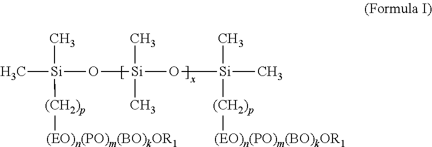

or compounds of Formula II:

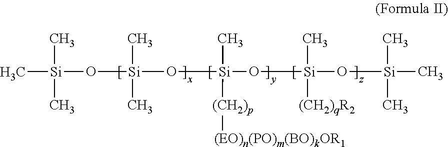

wherein x, y, z, p, q, k, m, and n are independently integers. For example, x and y can be greater than or equal to 1; z can be greater than or equal to 0; p and q can be greater than or equal to 1; k, n, and m can be greater than or equal to 0, where the sum of k, n, and m can be greater than or equal to 1. R₁ and R₂ are independently end groups chosen from hydrogen (H), (CH₂)ᵣCH₃ where r is an integer greater than or equal to 0, acetate, and (meth)acrylate; and EO is the oligomer or polymer derived from ethylene oxide, PO is the oligomer or polymer derived from propylene oxide, and BO is the oligomer or polymer derived from butylene oxide.

For the embodiments, the amount of the non-reactive polyether block copolymer additive used in the hardener component of the present invention is within a range of from 1 wt % to 20 wt %, more preferably within a range of from 2 wt % to 15 wt %, and still more preferably within a range of from 3 wt % to 10 wt %, based on a total weight the hardener component.

For the embodiments, it is believed that the non-reactive polyether block copolymer additive can undergo a microphase separation when the resin component and hardener component are mixed together. The microphase separation can form substantially uniformly dispersed and substantially uniformly scaled nano-sized micellar structures. Micellar structures can form in the curable composition due to micellization brought by the balance of the immiscible block segments and the miscible block segments. The immiscible micellar structures are preserved in the cured epoxy and increase the fracture resistance and impact resistance as compared to a cured epoxy without the non-reactive polyether block copolymer additive. Additionally, the present invention maintains the glass transition temperature, modulus, and tensile strength at similar levels as a cured epoxy without the non-reactive polyether block copolymer additive. For the embodiments, the micellar structures can include, but are not limited to, spherical, worm-like, and vesicles.

For the embodiments, the curing agent can be selected from compounds having an active group, e.g., a hydrogen group that is reactive with the epoxy group of the epoxy compound. For example, the curing agent can be selected from nitrogen-containing compounds such as amines and their derivatives. Additionally, oxygen-containing compounds such as carboxylic acid terminated polyesters, anhydrides, phenol-formaldehyde resins, amino-formaldehyde resins, phenol, bisphenol A, cresol-novalacs, and phenolic-terminated epoxy resins can be used as curing agents. Moreover, the curing agent can also be selected from sulfur-containing compounds such as polysulfides, polymercaptans and catalytic curing agents such tertiary amines, Lewis acids, and Lewis bases. For the embodiments, combinations of two or more curing agents may be used.

Some examples of curing agents that can be used in the present invention include, but are not limited to, polyamines, dicyandiamides, diaminodiphenylsulfones and their isomers, aminobenzoates, acid anhydrides, phenol-novalac resins, cresol-novolac resins, or mixtures thereof In one preferred embodiment, the curing agent is a combination of polyamidoamine, isophorone diamine, and polyoxypropylenediamin. For the embodiments, the curing agent is used within a range of from 50 wt % to 99 wt %, preferably within a range of from 60 wt % to 95 wt %, and more preferably within a range of 80 wt % to 90 wt %, based on the total weight of the hardener component.

As discussed above, it is advantageous for some curable compositions to have a viscosity to provide sufficient slump resistance such that the curable composition can be applied in various directions and in applications with large bonding gaps. However, in order to obtain sufficient slump resistance, previous approaches were limited to the types of curing agents used in the curable composition. For example, in order for the viscosity to increase quickly, some previous approaches were limited in choosing curing agents with acid dissociation constants (pKₐ) greater than 10. The higher the pKₐ value the faster the curing agent would react with epoxy groups and the faster the viscosity of the curable composition would begin to increase.

For the embodiments, the viscosity of the curable composition can increase quickly regardless of the pKₐ value of the curing agent. For example, curing agents with fast or slow pKₐ values may be used because the viscosity of the curable composition is predominately increased by the non-reactive polyether block copolymer additive. Therefore, for the embodiments, the reactivity of the curable composition can be controlled because the curing agent can be selected from curing agents with high pKₐ values, low pKₐ values, or mixtures thereof. The choice between curing agents of different reactivity allows the curing agent that best suits a process and/or application to be used versus being limited to curing agent of certain reactivity. Thus, for the embodiments, the curing agent can have a pKₐ value within a range of from 8 to 14.

As discussed above, the hardener component also includes the second filler. For the embodiments, the second filler is fumed silica and used in an amount of no greater than 10 wt %, based on the total weight of the hardener component. Additionally, the second filler can also include the other optional fillers described previously herein for the first filler. The other optional second fillers can be used in an amount within a range of from 1 wt % to 50 wt %, preferably within a range of from 2 wt % to 30 wt %, and more preferably within a range of from 3 wt % to 9 wt %, based on the total weight of the hardener component.

For applications where the bonding gap is 5 cm or greater, coefficients of thermal expansion of the various materials in the curable composition can be taken into consideration. For example, the coefficient of thermal expansion of glass fiber is largely different than the coefficient of thermal expansion of the epoxy compound. During curing, the largely different coefficients of thermal expansion can increase internal stresses and cause fractures.

A previous approach to overcome the different coefficients of thermal expansion was to add additional fillers, such as calcium carbonate, in an amount similar to the amount of the glass fibers used in the curable composition. However, balancing the coefficients of thermal expansion by adding additional fillers can also decrease the shear strength of the material.

For the embodiments, the non-reactive polyether block copolymer additive can reduce the amount of the first filler and the second filler used in the curable composition. The non-reactive polyether block copolymer additive can increase the toughness of the cured epoxy by increasing the fracture resistance and increasing the impact resistance as compared to a cured epoxy without the non-reactive polyether block copolymer additive. During curing, if fractures occur, the non-reactive polyether block copolymer additive can help prevent and/or help minimize the fractures from propagating. However, depending on the application, the curable composition can include the first filler and/or the second filler to help achieve various mechanical properties. For the embodiments, the amount of fillers used in the curable composition can be reduced as compared to a curable composition without the non-reactive polyether block copolymer additive.

For the embodiments, the curable compositions can include optional additives. Examples of optional additives include, but are not limited to, air release reagents, organic dyes or pigments, cellulose thickeners, accelerators, UV-absorbents, solvents, reinforcing agents, stabilizers, extenders, plasticizers, flame retardants, or mixtures thereof. For the embodiments, the optional additives may be present in the resin component, the hardener component, or both. The amount of the optional additives can be up to 70 wt %, based on the total weight of either the resin component or the hardener component.

For the embodiments, because the viscosity of the resin component and the hardener component remain relatively low, the two components can be thoroughly mixed and quickly dispensed. As discussed herein, the viscosity of the resin component and the hardener component do not increase prior to forming the curable composition. For the embodiments, the resin component has a viscosity within a range of from 1 Pa·s to 70 Pa·s, preferably within a range of from 5 Pa·s to 50 Pa·s, and more preferably within a range of from 10 Pa·s to 30 Pa·s at 25° C. and under an applied shear of 10 l/s. For the embodiments, the hardener component has a viscosity within a range of from 5 Pa·s to 30 Pa·s at 25° C. and under an applied shear of 10 l/s.

The resin component and hardener component are mixed together to form the curable composition. Upon contact, the viscosity of the curable composition can begin to increase. For the embodiments, the non-reactive polyether block copolymer additive can increase the viscosity of the curable composition and does not react with materials in the resin component or the other materials in the hardener component. The present invention can be advantageous in applications where fast dispensing and rapid bonding is required. For example, while the resin component and the hardener component are being mixed, a transition time for the viscosity of the curable composition to increase to greater than 100 Pa·s to provide sufficient slump resistance can be within a range of 10 seconds to 900 seconds, preferably within a range of from 30 seconds to 500 seconds, and more preferably within a range of from 50 seconds to 150 seconds.

For the embodiments, the non-reactive polyether block copolymer additive imparts thixotropy to the curable composition. For the embodiments, the curable composition during mixing under an applied shear of 10 l/s at 25° C. can have a viscosity within a range of from 100 Pa·s to 900 Pa·s. Additionally, the curable composition during mixing under an applied shear of 200 l/s at 25° C. under an applied shear of has a viscosity within a range of from 3 Pa·s to 15 Pa·s.

For the embodiments, after the mixing has stopped, i.e., once the applied shear is removed, the viscosity of the curable composition can continue to increase. For the embodiments, 900 seconds after mixing has stopped the curable composition can have a viscosity at 25° C. within a range of 100 Pa·s to 1000 Pa·s, preferably within a range of 300 Pa·s to 900 Pa·s, and more preferably within a range of 400 Pa·s to 600 Pa·s.

For the embodiments, the non-reactive polyether block copolymer additive can promote the aggregation of the fumed silica. Surprisingly, the non-reactive polyether block copolymer additive can minimize the amount of fumed silica that aggregates with the curing agent. In curable compositions without the non-reactive polyether block copolymer additive, the fumed silica can aggregate with the curing agents from hydrogen-bond interaction. For example, the curing agents are hydrogen-containing materials that can form hydrogen-hydrogen bonds between the particles of fumed silica aggregating them together. As hydrogens of the curing agent reacts with the fumed silica forming hydrogen-hydrogen bonds between fumed silica particles, it thereby decreases the availability of hydrogens of the curing agent that can react with the epoxy group of the epoxy compound. In contrast, the present invention provides for the aggregation of the fumed silica while minimizing the hydrogen-hydrogen bonds between the particles of fumed silica. Thus, for the embodiments, the non-reactive polyether block copolymer additive can provide for preferential aggregation between the fumed silica particles themselves and minimizes the aggregation of the fumed silica with the curing agents.

For the embodiments of the present invention, the resin component and the hardener component can be mixed together by known means in the art to form a curable composition. Mixing can be manual, mechanical or a combination thereof. Mixers can include, but are not limited to, a planetary mixer, dispensing the two components from separate component cartridges into a common conduit having a static mix head, where the components are mixed as they pass through the conduit, and/or other types of mixers.

For the embodiments, the curable composition can be formed by mixing all of the materials in the resin component together, mixing all of the materials in the hardener component together, and then combing the resin component with the hardener component to form the curable composition. Alternatively, all of the materials could be mixed together at once. Additionally, the hardener component, without the non-reactive polyether block copolymer additive, could be mixed with the resin component and then the non-reactive polyether block copolymer additive could be added after the two components have been mixed.

For the embodiments, the cured epoxy is formed by curing the curable composition. The temperature and time interval can vary, but the curable compositions can be cured at 70° C. for approximately 7 hours. Additional curing temperatures and time period may be used for the present invention. For example, the curing temperature can include temperatures within a range of from 10° C. to 150° C. The time period of a cure can range from minutes to several hours or days depending on the curing components, the final curable composition formulation, and/or the particular application. For the embodiments, the curable compositions can be cured in one step or multiple steps. Additionally, the curable composition can be post-cured using a different temperature or energy source after an initial cure.

Another advantage of the non-reactive polyether block copolymer additive is that the non-reactive polyether block copolymer additive can also help minimize crystallization of liquid epoxy resins and extend the shelf life of the liquid epoxy resins. Liquid epoxy resins that contain filler such as calcium carbonate can crystallize over time. To help prevent crystallization, bisphenol F can be added to the liquid epoxy resin. For the embodiments of the present invention, the addition of the non-reactive polyether block copolymer additive minimizes crystallization and removes the need for adding bisphenol F for crystallization prevention.

The curable compositions of the present invention may be advantageously used as an adhesive, and in particular, as an adhesive used to bond relatively large structures that include, but are not limited to, aerodynamic wings, wind turbine blades, and automobile components. The curable compositions can be applied to a surface of one or between one or more structures and then cured. For example, the structures can be metal, plastic, fiberglass, or another material that the curable compositions can bond to. The curable composition can be applied manually, by a machine dispensing, spraying, rolling, or other procedures.

### EXAMPLES

The following examples are given to illustrate, but not limit, the scope of this invention.

### Materials

Epoxy compound, D.E.R.™ 330 (DER 330), available from The Dow Chemical Company.

Epoxy compound, D.E.R.™ 331(DER 331), available from The Dow Chemical Company.

Epoxy compound, D.E.R.™ 332 (DER 332), available from The Dow Chemical Company.

Epoxy compound, D.E.R.™ 354 (DER 354), available from The Dow Chemical Company.

Diluent, POLYPOX™ R14 (Polypox), available from UPPC GmbH.

Non-reactive polyether block copolymer additive, FORTEGRA 100™ (Fortegra), available from The Dow Chemical Company.

Non-reactive polyether block copolymer additive, DOW CORNING® 1248 FLUID (DC 1248), available from The Dow Corning Corporation.

Non-reactive polyether block copolymer additive, DOW CORNING® 190 FLUID (DC 190), available from The Dow Corning Corporation.

Non-reactive polyether block copolymer additive, DOW CORNING® 5329 FLUID (DC 5329), available from The Dow Corning Corporation.

Diluent, POLYPOX® R14, (neopentylglycidylether), available from UPPC GmbH.

Diluent, C₁₂-C₁₄ Glycidylether, available from The Dow Chemical Company.

Curing agent, Versamid 140 (polyamidoamine), available from Cognis Corporation.

Curing agent, isophorone diamine (IPDA), available from Evonik Industries.

Curing agent, polyoxypropylenediamine, JEFFAMINE® D-230 (D-230), available from Huntsman International LLC.

Curing agent, diethylentriamin, DEH 20, available from The Dow Chemical Company.

Filler, HDK N 20 (fumed silica), available from Wacker.

Filler, glass fiber (SiO₂, FG 400/060), available from Schwarzwälder Textil-Werke.

Filler, Omycarb® (calcium carbonate), available from Mondo Minerals.

### Viscosity Test Method

The following viscosity measurements were performed on a Rheomat (Paar Physical Device DSR4000 SN241151) in a shear stress experiment with a plate/plate geometry having a diameter of 25 millimeter (mm) and a gap of 0.3 mm. First, a conditions step was completed at 25° C. A pre-shear was applied to the sample for 5 seconds and then was kept at equilibrium for 10 seconds. For each subsequent step, the shear rate was increased and samples were taken every 1 second for 10 minutes.

### Preparation of Resin Components

Table I shows the resin component formulations. The resin components include an epoxy compound, diluent and first filler. Table I shows the weight percent of the various components based on the total weight of the resin component.

TABLE I

| | Resin | Resin | Resin |
|---|---|---|---|
| | Component 0 | Component 1 | Component 2 |
| | wt % | wt % | wt % |
| Epoxy Compound | 75 | — | — |
| DER 330 | | | |
| Epoxy Compound | — | 75 | — |
| DER 331 | | | |
| Epoxy Compound | — | — | 60 |
| DER 332 | | | |
| Epoxy Compound | — | — | 15 |
| DER 354 | | | |
| Diluent | 15 | 15 | — |
| POLYPOX ® R14 | | | |
| Diluent | — | — | 15 |
| C₁₂-C₁₄ Glycidylether | | | |
| Filler | 10 | 10 | 10 |
| Wacker HDK N 20 | | | |
| Total | 100 | 100 | 100 |

Various non-reactive polyether block copolymer additives were added to the resin components for examination. The low, middle, and high shear viscosity of Resin Components 0, 1, and 2 including the various non-reactive polyether block copolymer additives were measured at 25° C. The results are shown in Table II.

TABLE II

| | Shear | Resin | Resin Component | Resin Component | Resin Component | Resin | Resin Component | Resin Component | Resin |
|---|---|---|---|---|---|---|---|---|---|
| | Rate | Compo- | 0 + 1 wt % | 0 + 1 wt % | 0 + 1 wt % | Compo- | 1 + 1 wt % | 1 + 5 wt % | Compo- |
| | (1/s) | nent 0 | DC 1248 | DC 190 | DC 5329 | nent 1 | Fortegra | Fortegra | nent 2 |
| Low Shear | 5 | 80-100 | 40-225 | 100-425 | 50-650 | 160-210 | 100-260 | 70-250 | 10-25 |
| Viscosity | | | | | | | | | |
| (Pa · s) | | | | | | | | | |
| Middle | 500 | 30-35 | 30-40 | 60-80 | 20-90 | 30-35 | 20-25 | 13-21 | 7-10 |
| Shear | | | | | | | | | |
| Viscosity | | | | | | | | | |
| (Pa · s) | | | | | | | | | |
| High Shear | 1000 | 16 | 8-9 | 20-30 | 10-20 | 18-18 | 10 | 8 | 6 |
| Viscosity | | | | | | | | | |
| (Pa · s) | | | | | | | | | |

In Table II, some of the viscosity measurements are illustrated as two measurements (a first and second value). The viscosities were measured in a hysteresis loop, i.e, adjusting the shear rate from 5 l/s up to 1000 l/s and then back to 5 l/s. Viscosity measurements were taken at 5 l/s, 500 l/s, and 1000 l/s. The first value is the viscosity measurements obtained on the portion of the loop back from 1000 l/s to 5 l/s, i.e, the return to lower shear. The second value is the viscosity measurements obtained on the initial portion of the loop from 5 l/s up to 1000 l/s, i.e., the increase to high shear. It can be seen in Table II that the addition of the non- reactive polyether block copolymer additive can significantly increase the viscosity and thixotropy of the resin component formulations. As discussed above, it is advantageous to maintain the viscosity of the resin component and the hardener component to below 30 Pa·s at 25° C. at an applied shear of 5 l/s.

It was determined that it is not preferable to add the non-reactive polyether block copolymer to the resin component. Thus, the non-reactive polyether block copolymer additive was added to the hardener component and analyzed.

### Preparation of Hardener Components

Table III shows the hardener component formulations. The hardener components include a curing agent, a second filler, and a non-reactive polyether block copolymer additive. Table III shows the weight percent of the various components of the hardener component based on the total weight of the hardener component.

TABLE III

| | Hardener | Hardener | Hardener |
|---|---|---|---|
| | Component | Component | Component |
| | 0 | 1 | 2 |
| | wt % | wt % | wt % |
| Curing Agent | 35.0 | 35.0 | 38.0 |
| Versamid 140 | | | |
| Curing Agent | 25.0 | 25.0 | 27.0 |
| IPDA | | | |
| Curing Agent | 5.0 | 5.0 | 5.0 |
| JEFFAMINE D-230 | | | |
| Curing Agent | — | — | 5.0 |
| DEH 20 | | | |
| Non-reactive polyether block | — | 3.5 | — |
| copolymer additive | | | |
| DC 5329 | | | |
| Non-reactive polyether block | — | — | 5.0 |
| copolymer additive | | | |
| Fortegra | | | |
| Filler | 5.0 | 5.0 | 10.0 |
| SiO2 (Glass Fibers) | | | |
| Filler | 25.0 | 25.0 | 4.0 |
| Calcium Carbonate | | | |
| Fumed Silica | 5.0 | 1.5 | 6.0 |
| Wacker HDK N 20 | | | |
| Total | 100 | 100 | 100 |

The low, middle, and high shear viscosity of Hardener Components 0, 1, and 2 were measured at 25° C. The results are shown in Table IV.

TABLE IV

| | Shear | | | |
|---|---|---|---|---|
| | Rate | Hardener | Hardener | Hardener |
| | (1/s) | Component 0 | Component 1 | Component 2 |
| Low Shear | 10 | 70-150 | 100-160 | 10-30 |
| Viscosity | | | | |
| (Pa · s) | | | | |
| Middle Shear | 500 | 9 | 8-9 | 8-9 |
| Viscosity | | | | |
| (Pa · s) | | | | |
| High Shear | 1000 | 8 | 8 | 8 |
| Viscosity | | | | |
| (Pa · s) | | | | |

In Table IV, some of the viscosity measurements are illustrated as two measurements (a first and second value). The viscosities were measured in a hysteresis loop, i.e., adjusting the shear rate from 10 l/s to 1000 l/s and then back to 5 l/s. Viscosity measurements were taken at 10 l/s, 500 l/s, and 1000 l/s. The first value is the viscosity measurements obtained on the portion of the loop back from 1000 l/s to 10 l/s, i.e, the return to lower shear. The second value is the viscosity measurements obtained on the initial portion of the loop from 10 l/s up to 1000 l/s, i.e., the increase to high shear

As seen in Table IV, the low, middle, and high shear viscosity of Hardener Component 0 (without the non-reactive polyether block copolymer additive) and Hardener Component 1 (containing the non-reactive polyether block copolymer additive) remain at substantially similar values. Additionally, the low shear viscosity of Hardener Component 2 (containing the non-reactive polyether block copolymer) is substantially below the viscosity of Hardener Component 1 and the middle and high shear viscosities are substantially the same as Hardener Component 1. Thus, Table IV illustrates that the addition of the non-reactive polyether block copolymer additive does not significantly increase the viscosity of the hardener component.

### Example 1

Example 1 was prepared by combining a resin component and a hardener component to form a curable composition. Table V shows the composition for Example 1 based on a weight ratio of the resin component to the hardener component.

TABLE V

Curable Composition

| | Resin Component 2 | Hardener Component 2 |
|---|---|---|
| Example 1 | 100 | 50 |

### COMPARATIVE EXAMPLES A AND B

Comparative Examples A and B were prepared by combining a resin component and a hardener component to form a curable composition. Table VI shows the composition for Comparative Examples A and B based on a weight ratio of the resin component to the hardener component.

TABLE VI

| | Curable Composition | | |
|---|---|---|---|
| | Resin Component | | |
| | Resin | Resin | Hardener Component |
| | Component 0 | Component 2 | Hardener Component 0 |
| Comparable | 100 | — | 50 |
| Example A | | | |
| Comparable | — | 100 | 50 |
| Example B | | | |

### Viscosity Testing

The viscosity was measured as the resin component and the hardener component are being mixed together under an applied shear of 10 l/s. Viscosity measurements were taken every 20 seconds at 25° C. and are shown in Table VII.

TABLE VII

| | | Time of mixing (sec) | | | | | | | | | | | |
|---|---|---|---|---|---|---|---|---|---|---|---|---|---|
| | | 0 | 20 | 40 | 60 | 80 | 100 | 120 | 200* | 300* | 400* | 500* | 600* |
| Example 1 | Viscosity | 20 | 22 | 40 | 60 | 100 | 150 | 200 | 300 | 450 | 600 | 650 | 700 |
| | (Pa · s) | | | | | | | | | | | | |
| Comparative | Viscosity | 10 | 20 | 35 | 50 | 80 | 107 | 150 | 200 | 400 | 500 | 600 | 640 |
| Example A | (Pa · s) | | | | | | | | | | | | |

*The values have been extrapolated from the viscosity curve derived from the values from 0-120 seconds.

As seen in Table VII, the viscosity of Example 1 (containing the non-reactive polyether block copolymer additive) increases more rapidly than Comparative Example A (without the non-reactive polyether block copolymer additive). Additionally, referring to Tables II and IV, the low shear viscosity of the two components of Example 1 prior to forming the curable composition are less than 30 Pa·s at 25° C. In contrast, the low shear viscosity of the two components of Comparative Example A prior to forming the curable composition are greater than or equal to 80 Pa·s at 25° C. for the resin component and greater than or equal to 70 Pa·s at 25° C. for the hardener component.

A viscosity profile of the curable compositions for Example 1 and Comparative Example A at 25° C. was obtained by performing a hysteresis loop, i.e., shear rate from 10 l /s to 200 l/s and back to 10 l/s. The results are shown in Table VIII. The first values for the shear rate of 10 l/s is the viscosity value when the shear rate was returned to 10 l/s and the second value is the initial viscosity at the shear rate of 10 l/s.

TABLE VIII

| | | Shear rate (1/s) | | | | |
|---|---|---|---|---|---|---|
| | | 10 | 50 | 100 | 150 | 200 |
| Example 1 | Viscosity | 100-500 | 15 | 13 | 11 | 8 |
| | (Pa · s) | | | | | |
| Comparative | Viscosity | 80-300 | 16 | 15 | 14 | 12 |
| Example A | (Pa · s) | | | | | |

As seen in Table VIII, the addition of the non-reactive polyether block copolymer additive can substantially increase the initial viscosity of the curable composition. For example, Example 1 has an initial viscosity of 500 Pa·s whereas Comparative Example A has an initial viscosity of 300 Pa·s. Moreover, the added thixotropy to the curable composition can be seen as the high shear viscosity of Example 1 is less than that of Comparative Example A.

### Toughness Testing

Impact Resistance: The impact resistance of the cured epoxy formed from the curable composition was tested by using a BYK-Gardener impact tester according to ISO 6272 (1 Kilogram (kg) falling weight). The falling height of the falling weight was increased until the cast broke apart.

Impact testing was determined for Example 1 and Comparative Example A. Test specimens were prepared by making 100 grams (g) of Example 1 and Comparative Example A. The curable compositions were cast into 8.5 centimeter (cm) diameter aluminum dishes with a 0.7 cm thickness. The curable compositions were cured at 70° C. for 7 hours. The toughness of the cured examples was tested and the results, which are given as a falling height in meters (m) as to when the test specimen fractured, are shown in Table IX.

TABLE IX

| | Falling Height | Impact Energy |
|---|---|---|
| | (m) | (Joule) |
| Example 1 | 1.1 | 10.78 |
| Comparative Example A | 0.9 | 8.82 |

As seen in Table IX, Example 1 (containing the non-reactive polyether block copolymer) has a greater falling height than Comparative Example A (without the non-reactive polyether block copolymer). Thus, the addition of the non-reactive polyether block copolymer additive increases the impact resistance of the cured epoxy formed from the curable compositions of the present invention.

Facture Resistance: Fracture resistance was determined for Example 1 and Comparative Example B. The critical stress intensity coefficient, K_{1C}, was measured according to ISO 13586 at 25° C. and the results are shown in Table X. The higher the K_{1C} value of a material, the better the material is resistance to crack initiation.

The test specimens were prenotched with a diamond saw. A fine crack is produced on the test specimens, clamped in a vice, using a razor blade by gently tapping the razor blade that leads to cracking. This makes it possible to obtain a very fine crack root, similar to a natural crack. The total depth of the notch is measured using a binocular magnifier.

TABLE X

| | | Comparative |
|---|---|---|
| | Example 1 | Example B |
| K_{1C} | 2.33 +/− 0.09 | 1.3 +/− 0.07 |
| (MPa · m\hat{ }0.5) | | |

As seen in Table X, Example 1 (containing the non-reactive polyether block copolymer additive) has a higher K_{1C} value than Comparative Example B (without the non-reactive polyether block copolymer). Thus, the non-reactive polyether block copolymer additive increases the fracture resistance of the cured epoxy formed from the curable compositions of the present disclosure.

### Crystallization

Preventing crystallization by adding the non-reactive polyether block copolymer additive to liquid epoxy resins was analyzed. The non-reactive polyether block copolymer additive was added to samples of liquid epoxy. The samples were allowed to sit for 6 months in a laboratory at 25° C. at 50% relative humidity. The crystallization was determined by a visual inspection and the results are shown in Table XI.

TABLE XI

| | | Visual Inspection |
|---|---|---|
| | | after 6 months |
| | | (25° C./ |
| | Composition | 50% relative humidity) |
| Liquid Epoxy Sample 1 | DER 330 + 1 wt % | Clear |
| | Fortegra | |
| Liquid Epoxy Sample 2 | DER 330 + 1 wt % | Clear |
| | Fortegra | |
| Liquid Epoxy Comparative | DER 300 | Turbid |
| Sample A | | |
| Liquid Epoxy Comparative | DER 330 | Turbid |
| Sample B | | |

Liquid Epoxy Samples 1 and 2 remained clear while the Liquid Epoxy Comparative Samples A and B turned turbid over the 6 month interval. Thus, the addition of the non-reactive polyether block copolymer additive to the epoxy resins has increased the crystallization resistance of the epoxy resin as compared to epoxy resins without the non-reactive polyether block copolymer additive.

1. A curable composition, comprising:
(A) a resin component, comprising:
(i) an epoxy compound, (ii) a diluent, and (iii) a first filler in an amount no greater than 10 weight percent based on a total weight of the resin component; and
(B) a hardener component, comprising:
(iv) a curing agent, (v) a second filler in an amount no greater than 10 weight percent based on a total weight of the resin component, and (vi) a non-reactive polyether block copolymer additive in an amount from 1 weight percent to 20 weight percent based on a total weight of the hardener component;
wherein the resin component and hardener component each have a viscosity of no greater than 30 Pascal-second under an applied shear of 10 reciprocal seconds at 25 degrees Celsius and the curable composition after 120 seconds of mixing the resin component and the hardener component together under an applied shear of 10 reciprocal seconds has a viscosity of at least 100 Pascal-second at 25 degrees Celsius.

2. The curable composition of claim 1, wherein the curable composition during mixing at 25° C. under an applied shear of 10 reciprocal seconds has a viscosity within a range of from 100 Pascal-second to 900 Pascal-second.

3. The curable composition of claim 1, wherein the curable composition during mixing at 25° C. under an applied shear of 200 reciprocal seconds has a viscosity within a range of from 3 Pascal-second to 15 Pascal-second.

4. The curable composition of claim 1, wherein the non-reactive block copolymer additive is 5 weight percent based on the total weight of the hardener component.

5. The curable composition of claim 1, wherein the diluent is within a range of from 3 weight percent to 20 weight percent based on the total weight of the resin component.

6. The curable composition of claim 1, wherein the first filler and second filler are fumed silica, wherein the fumed silica in the first filler is used in an amount of 10 weight percent based on the total weight of the resin component and the fumed silica in the second filler is used in an amount of 6 weight percent based on the total weight of the hardener component.

7. The curable composition of claim 6, wherein the second filler further includes glass fiber and is used an amount within a range of from 1 weight percent to 50 weight percent, based on the total weight of the hardener component.

8. The curable composition of claim 6, wherein particles of the fumed silica are substantially free of hydrogen-hydrogen bonds.

9. A process for preparing a curable composition comprising the steps of
(a) forming a resin component having a viscosity of no greater than 30 Pascal-second at 25 degrees Celsius by mixing together (i) an epoxy compound, (ii) a diluent, and (iii) a first filler;
(b) forming a hardener component having a viscosity of no greater than 30 Pascal-second at 25 degrees Celsius by mixing together (iv) a curing agent, (v) a second filler, and (vi) a non-reactive polyether block copolymer additive; and
(c) mixing the resin component and the hardener component together to form the curable composition;
wherein after 120 seconds of mixing the resin component and hardener component together the curable composition has a viscosity of at least 100 Pascal-second at 25 degrees Celsius.

10. The process of claim 9, further including selecting the curing agent from curing agents that have an acid dissociation constant within a range of from 8 to 14.

11. The process of claim 9, further including applying the curable composition to a surface when the curable composition has a viscosity within a range of from 10 Pascal-second to 20 Pascal-second during mixing at 25° C. under an applied shear of 200 reciprocal seconds.

12. Two or more structures bonded together with a cured epoxy of the curable composition of claim 1.
